(19) United States
(12) Patent Application Publication
(10) Pub. No.: US 2023/0335768 A1
(43) Pub. Date: Oct. 19, 2023

(54) SOLID OXIDE FUEL CELL AND MANUFACTURING METHOD OF THE SAME

(71) Applicant: TAIYO YUDEN CO., LTD., Tokyo (JP)

(72) Inventor: Xinyu LI, Tokyo (JP)

(73) Assignee: TAIYO YUDEN CO., LTD., Tokyo (JP)

(21) Appl. No.: 18/028,093

(22) PCT Filed: Jul. 1, 2021
(86) PCT No.: PCT/JP2021/024955

§ 371 Date: Mar. 23, 2023

(30) Foreign Application Priority Data
Oct. 8, 2020 (JP) 2020-170421

(51) Int. Cl. H01M 8/1226

(52) U.S. Cl. CPC H01M 8/1226; H01M 2008/1293

(57) ABSTRACT

A solid oxide fuel cell includes an electrolyte layer including a solid oxide having oxide ion conductivity, an intermediate layer that is provided on the electrolyte layer and has oxide ion conductivity, and a cathode provided on the intermediate layer, wherein the electrolyte layer has a plurality of convex portions arranged in dimensional directions in a plan view, on a face thereof on the side of the intermediate layer, and wherein a face of the intermediate layer on the side of the cathode follows a shape of the face of the electrolyte layer on the side of the intermediate layer.

### TECHNICAL FIELD

The present invention relates to a solid oxide fuel cell and a manufacturing method of the solid oxide fuel cell.

### BACKGROUND ART

A solid oxide fuel cell has a structure in which a solid oxide electrolyte is sandwiched between an anode and a cathode. The cathode used in such solid oxide fuel cells may react with the solid oxide electrolyte. Therefore, in order to suppress the reaction between the solid oxide electrolyte and the cathode, a technique is disclosed in which a reaction prevention film such as GDC is provided between the cathode and the solid oxide electrolyte (see, for example, Patent Document 1).

### PRIOR ART DOCUMENT

### Patent Document

Patent Document 1: Japanese Patent Application Publication No. 2017-504946

### DISCLOSURE OF THE INVENTION

### Problems to Be Solved by the Invention

However, if the reaction prevention film is provided, the reaction resistance during power generation may increase.

The present invention has been made in view of the above problems, and an object of the present invention is to provide a solid oxide fuel cell capable of reducing reaction resistance and a method of manufacturing the same.

### Means for Solving the Problems

A solid oxide fuel cell of the present invention is characterized by including: an electrolyte layer including a solid oxide having oxide ion conductivity; an intermediate layer that is provided on the electrolyte layer and has oxide ion conductivity; and a cathode provided on the intermediate layer, wherein the electrolyte layer has a plurality of convex portions arranged in dimensional directions in a plan view, on a face thereof on the side of the intermediate layer, and wherein a face of the intermediate layer on the side of the cathode follows a shape of the face of the electrolyte layer on the side of the intermediate layer.

In the above-mentioned solid oxide fuel cell, the plurality of convex portions may have a grain shape.

In the above-mentioned solid oxide fuel cell, the electrolyte layer may include a plurality of crystal grains, the convex portions may protrude toward the intermediate layer from the crystal grain on a surface of the electrolyte layer on the side of the intermediate layer, and the crystal grains on the surface of the electrolyte layer on the side of the intermediate layer may be larger than the convex portions.

In the above-mentioned solid oxide fuel cell, a size of the crystal grains on the surface of the electrolyte layer on the side of the intermediate layer may be 1 µm or more and 5 µm or less.

In the above-mentioned solid oxide fuel cell, a number of the convex portions on each of the crystal grains on the surface of the electrolyte layer on the side of the intermediate layer may be 3 to 15, in a plan view with respect to the electrolyte layer.

In the above-mentioned solid oxide fuel cell, there may be no crystal grain boundary between at least one of the convex portions and the crystal grains on the surface of the electrolyte layer on the side of the intermediate layer.

In the above-mentioned solid oxide fuel cell, a size of the convex portions may be in a range of 0.05 to 0.8 times as a size of the crystal grains on the surface of the electrolyte layer on the side of the intermediate layer.

In the above-mentioned solid oxide fuel cell, a height of the convex portions may be in a range of 0.025 to 0.4 times as a size of the crystal grains on the surface of the electrolyte layer on the side of the intermediate layer.

In the above-mentioned solid oxide fuel, a size of the convex portions may be 0.2 µm or more and 1.5 µm or less.

A manufacturing method of a solid oxide fuel cell of the present invention is characterized by including: forming an electrolyte layer green sheet by applying slurry including oxide ion conductive material powder; applying slurry including oxide ion conductive material powder and resin particles on the electrolyte layer green sheet and, after that, firing the electrolyte layer green sheet, the oxide ion conductive material powder having a D50% particle diameter smaller than a D50% particle diameter of the oxide ion conductive material powder of the electrolyte layer green sheet; forming an intermediate layer on an electrolyte layer obtained by the firing, the intermediate layer having oxide ion conductivity and not having cathode activity; and forming a cathode on the intermediate layer.

### Effects of the Invention

According to the present invention, it is possible to provide a solid oxide fuel cell capable of reducing reaction resistance and a manufacturing method of the solid oxide fuel cell.

### BRIEF DESCRIPTION OF THE DRAWINGS

FIG. 1 is a schematic cross-sectional view of a stacking structure of a solid oxide fuel cell;

FIG. 2 is an enlarged cross-sectional view illustrating details of a support, a mixed layer, and an anode;

FIG. 3A illustrates an enlarged cross sectional view from an electrolyte layer to a cathode;

FIG. 3B illustrates a plan view of an electrolyte layer;

FIG. 4 illustrates a plan view of an electrolyte layer;

FIG. 5A and FIG. 5B are for describing a size of a convex portion;

FIG. 6 illustrates a flow of a manufacturing method of a fuel cell; and

FIG. 7 illustrates electrolyte layer green sheets and uneven layer green sheets in a stacking process.

### BEST MODES FOR CARRYING OUT THE INVENTION

Hereinafter, an embodiment will be described with reference to the accompanying drawings.

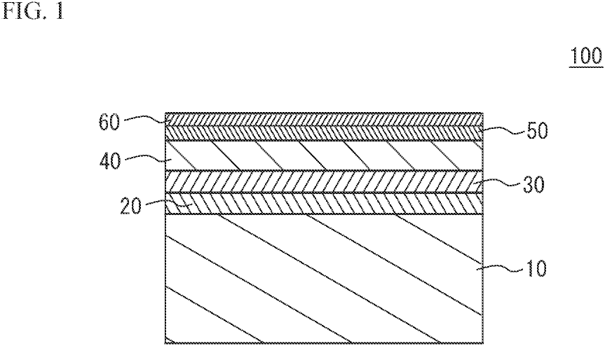

FIG. 1 is a schematic cross-sectional view of a stacking structure of a solid oxide fuel cell 100. As illustrated in FIG. 1, the fuel cell 100 has, as an example, a structure in which a mixed layer 20, an anode 30, an electrolyte layer 40, an intermediate layer 50 and a cathode 60 are stacked on a support 10 in this order. A plurality of the fuel cells 100 may be stacked to structure a fuel cell stack.

The electrolyte layer 40 is a dense layer that is mainly composed of solid oxide having oxygen ion conductivity and has gas impermeability. The electrolyte layer 40 is preferably mainly composed of scandia-yttria-stabilized zirconium oxide (ScYSZ), YSZ (yttria-stabilized zirconium oxide), GDC (Gd-doped ceria) in which CeO₂ is doped with Gd (gadolinium), or the like. When the ScYSZ is used, the oxygen ion conductivity is the highest when the concentration of Y₂O₃ + Sc₂O₃ is 6 mol% to 15 mol%. Thus, use of a material having this composition is preferable. The thickness of the electrolyte layer 40 is preferably 20 µm or less, further preferably 10 µm or less. The thinner electrolyte layer is better. However, to prevent gas at the upper face side and gas at the lower face side from leaking, the thickness is preferably 1 µm or greater.

The cathode 60 is an electrode having electrode activity as a cathode, and has electron conductivity and oxygen ion conductivity. For example, the cathode 60 is mainly composed of a ceramic material having electronic conductivity and oxide ion conductivity. As the ceramic material, for example, LaCoO₃-based material, LaMnO₃-based material, LaFeO₃-based material or the like can be used. For example, LSC (lanthanum strontium cobaltite) or the like can be used as the LaCoO₃-based material. LSC is LaCoO₃ doped with Sr (strontium).

The intermediate layer 50 is mainly composed of a component that prevents reaction between the electrolyte layer 40 and the cathode 60. The constituent material of the intermediate layer 50 is different from the constituent material of the electrolyte layer 40. The intermediate layer 50 has oxide ion conductivity, but does not have electrode activity as a cathode. For example, the intermediate layer 50 has a structure in which additives are added to ceria (CeO₂). Additives are not particularly limited. For example, the intermediate layer 50 is mainly composed of GDC (for example, Ce_{0.8}Gd_{0.2}O₂₋ₓ). As an example, if the electrolyte layer 40 contains ScYSZ and the cathode 60 contains LSC, the intermediate layer 50 prevents the following reactions.

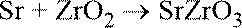

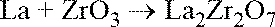

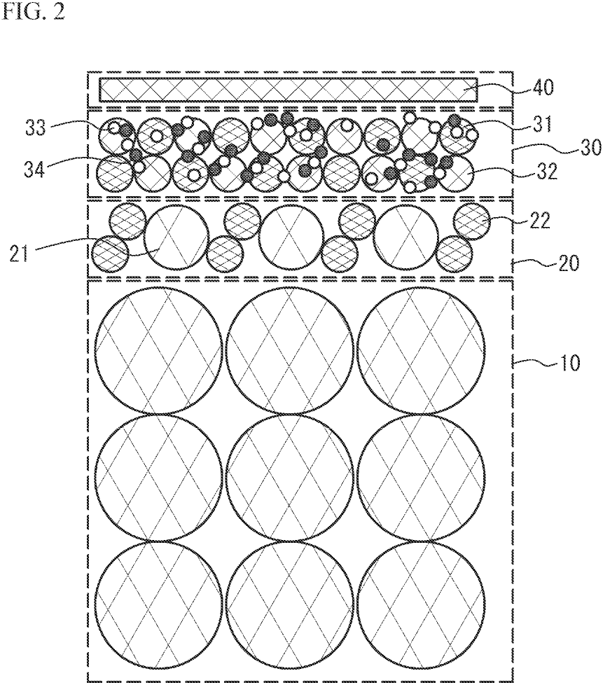

FIG. 2 is an enlarged cross-sectional view illustrating details of the support 10, the mixed layer 20, and the anode 30. As illustrated in FIG. 2, the support 10 is a member that has gas permeability and is able to support the mixed layer 20, the anode 30, the electrolyte layer 40, the intermediate layer 50, and the cathode 60. The support 10 is a porous metallic material, and is, for example, a porous material of Fe—Cr alloys.

The anode 30 is an electrode having electrode activity as an anode, and has an electrode bone structure made of a ceramic material. The electrode bone structure contains no metallic component. In this configuration, decrease in the porosity in the anode due to coarsening of a metallic component is inhibited during firing in a high-temperature reductive atmosphere. Additionally, alloying with a metallic component of the support 10 is inhibited, and deterioration of the catalyst function is inhibited.

The electrode bone structure of the anode 30 preferably has electron conductivity and oxygen ion conductivity. The anode 30 preferably contains an electron conductive ceramic 31. The electron conductive ceramic 31 can be a perovskite-type oxide expressed by the composition formula of ABO₃ where the A site is at least one selected from a group consisting of Ca, Sr, Ba, and La, and the B site includes at least one selected from a group consisting of Ti and Cr. The mole fraction of the B site may be equal to or greater than the mole fraction of the A site (B ≥ A). More specifically, the electron conductive ceramic 31 can be a LaCrO₃-based material, SrTiO₃-based material, or the like.

The electrode bone structure of the anode 30 preferably contains an oxide ion conductive ceramic 32. The oxide ion conductive ceramic 32 is ScYSZ or the like. For example, it is preferable to use ScYSZ having the following composition range. Scandia (Sc₂O₃) is 5 mol% to 16 mol%, and yttria (Y₂O₃) is 1 mol% to 3 mol%. It is more preferable to use ScYSZ of which the total additive amount of scandia and yttria is 6 mol% to 15 mol%. This is because the highest oxide ion conductivity is obtained in this composition range. The oxide ion conductive ceramic 32 is, for example, a material with a transference number of oxide ion of 99% or greater. GDC may be used as the oxide ion conductive ceramic 32. In the example of FIG. 2, a solid oxide identical to the solid oxide contained in the electrolyte layer 40 is used as the oxide ion conductive ceramic 32.

As illustrated in FIG. 2, in the anode 30, for example, the electron conductive ceramic 31 and the oxide ion conductive ceramic 32 form the electrode bone structure. This electrode bone structure forms a plurality of pores. An anode catalyst is carried on the surface exposed to the pore of the electrode bone structure. Thus, in the spatially continuously formed electrode bone structure, a plurality of anode catalysts are spatially dispersed. A composite catalyst is preferably used as the anode catalyst. For example, an oxide ion conductive ceramic 33 and a catalyst metal 34 are preferably carried, as a composite catalyst, on the surface of the electrode bone structure. The oxide ion conductive ceramic 33 may be, for example, BaCe₁₋ ₓZrₓO₃ doped with Y (BCZY, x = 0 to 1), SrCe₁₋ₓZrₓO₃ doped with Y (SCZY, x = 0 to 1), LaScO₃ doped with Sr (LSS), or GDC. Ni or the like may be used as the catalyst metal 34. The oxide ion conductive ceramic 33 may have a composition identical to that of the oxide ion conductive ceramic 32, or may have a composition different from that of the oxide ion conductive ceramic 32. A metal acting as the catalyst metal 34 may be in a form of compound when electric power is not generated. For example, Ni may be in a form of a nickel oxide (NiO). These compounds are reduced with a reductive fuel gas supplied to the anode 30, and becomes in a form of metal acting as an anode catalyst.

The mixed layer 20 contains a metallic material 21 and a ceramic material 22. In the mixed layer 20, the metallic material 21 and the ceramic material 22 are randomly mixed. Thus, a structure in which a layer of the metallic material 21 and a layer of the ceramic material 22 are stacked is not formed. The mixed layer is porous. A plurality of pores is formed. The metallic material 21 is not particularly limited as long as the metallic material 21 is a metal. In the example of FIG. 2, a metallic material identical to the metallic material of the support 10 is used as the metallic material 21. For example, ScYSZ, GDC, a SrTiO₃-based material, or a LaCrO₃-based material can be used as the ceramic material 22. Since the SrTiO₃-based material and the LaCrO₃-based material have high electron conductivity, the ohmic resistance in the mixed layer 20 can be reduced.

The fuel cell 100 generates power by the following actions. An oxidant gas containing oxygen, such as air, is supplied to the cathode 60. At the cathode 60, oxygen reaching the cathode 60 reacts with electrons supplied from an external electric circuit to become oxide ions. The oxide ions conduct through the intermediate layer 50 and the electrolyte layer 40 to move to the anode 30 side. On the other hand, a fuel gas containing hydrogen, such as a hydrogen gas or a reformed gas, is supplied to the support 10. The fuel gas reaches the anode 30 through the support 10 and the mixed layer 20. Hydrogen reaching the anode 30 release electrons at the anode 30 and reacts with oxide ions conducting through the electrolyte layer 40 from the cathode 60 side to become water (H₂O). The released electrons are drawn out to the outside by the external electric circuit. The electrons drawn out to the outside are supplied to the cathode 60 after doing electric work. Through the above-described actions, electric power is generated.

In the fuel cell 100 provided with the intermediate layer 50, the interface where the intermediate layer 50 and the cathode 60 are in contact is the place that contributes most to the cathode reaction. The area of this contact interface is inversely proportional to the reaction resistance. Therefore, the larger the contact area per unit area is, the lower the reaction resistance per unit area is. In view of the above, increasing the contact area between the intermediate layer 50 and the cathode 60 is a subject of development of the fuel cell 100.

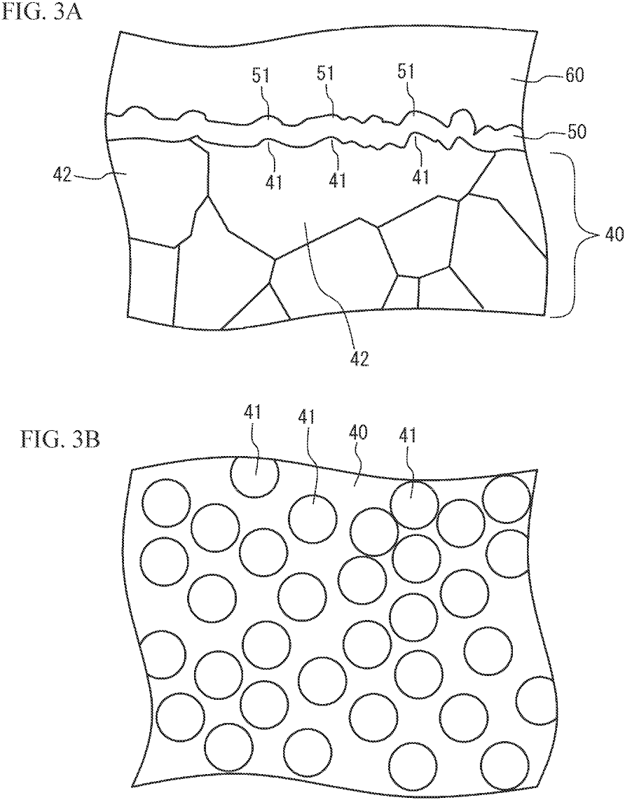

Therefore, the fuel cell 100 according to this embodiment has a structure that improves the contact area between the intermediate layer 50 and the cathode 60. FIG. 3A is an enlarged cross-sectional view from the electrolyte layer 40 to the cathode 60. FIG. 3B is a diagram illustrating the electrolyte layer 40 in plan view. As illustrated in FIG. 3A, the electrolyte layer 40 is formed with a plurality of convex portions 41 arranged at predetermined intervals on the face thereof on the intermediate layer 50 side. The convex portion 41 protrudes toward the intermediate layer 50. As exemplified in FIG. 3B, the directions in which the convex portions 41 are arranged are not limited to one direction, but are arranged two-dimensionally within the plane of the electrolyte layer 40. The two-dimensional directions do not necessarily have to be orthogonal to each other within the plane of the electrolyte layer 40 as long as they intersect. In a plan view of the electrolyte layer 40, the convex portions 41 are in the form of particles and are randomly arranged in the plane of the electrolyte layer 40.

Since the electrolyte layer 40 has the plurality of convex portions 41 on the intermediate layer 50 side, the intermediate layer 50 also has unevenness along the unevenness formed by the plurality of convex portions 41. That is, as illustrated in FIG. 3A, the intermediate layer 50 has a convex portion 51 formed on the cathode 60 side so as to follow the shape of the convex portions 41. That is, in a plan view of the electrolyte layer 40, the positions of the convex portions 41 and the convex portions 51 substantially coincide with each other. Therefore, the intermediate layer 50 is also formed with the unevenness arranged in two-dimensional directions within the plane. The intermediate layer 50 has a concave portion formed along the shape of the convex portion 41 on the electrolyte layer 40 side face.

Since the intermediate layer 50 has the plurality of convex portions 51 on the cathode 60 side, the face of the cathode 60 on the intermediate layer 50 side also has unevenness along the unevenness formed by the plurality of convex portions 51. Therefore, the area of the contact interface between the intermediate layer 50 and the cathode 60 is increased. In addition, since the directions in which the unevenness of the intermediate layer 50 and the cathode 60 are arranged are aligned two-dimensionally within the plane, the area of the contact interface between the intermediate layer 50 and the cathode 60 becomes larger. With this configuration, the number of reaction fields per unit area increases, and the reaction resistance of the cathode 60 can be reduced.

Since the unevenness is formed on the both faces of the intermediate layer 50 so that the positions of the convex portions 41 and the convex portions 51 substantially match each other in a plan view of the electrolyte layer 40, the intermediate layer 50 is prevented from being partially thickened. And the distance between the electrolyte layer 40 and the cathode 60 is shortened. Therefore, the reaction resistance of the cathode 60 can be lowered.

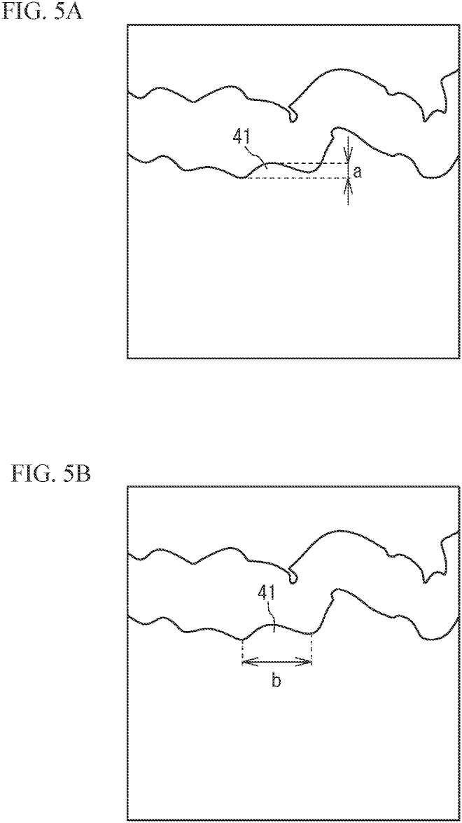

If the convex portion 41 is too large, the contact area between the intermediate layer 50 and the cathode 60 may become small. Therefore, it is preferable to provide an upper limit to the size of the convex portion 41. The size of the convex portion 41 is, for example, preferably 1.5 µm or less, more preferably 1 µm or less, and even more preferably 0.5 µm or less. When the surface of the intermediate layer 50 is observed with a SEM (scanning electron microscope), the convex portions 41 having nearly spherical shape are observed as illustrated in FIG. 3B. The size of the convex portion 41 is substantially the same as the concave-convex interval “b” illustrated in FIG. 5B.

Also, the average size of each of the convex portions 41 is preferably 1.5 µm or less, more preferably 1 µm or less, and even more preferably 0.5 µm or less. Three or more SEM photographs of the cross section are taken at a magnification of 10,000 times, the concave-convex interval “b” on the surface of each photograph is measured, and the average value is taken as the average size.

On the other hand, if the convex portions 41 are too small, it is difficult for the cathode material to enter the concave portion, and as a result, the contact between the cathode 60 and the intermediate layer 50 may be point contact. As a result, the contact area between the cathode 60 and the intermediate layer 50 becomes smaller, which may cause a problem such as an increase in reaction resistance. Therefore, it is preferable to set a lower limit for the size of the convex portion 41. The size of the convex portion 41 is, for example, preferably 0.2 µm or more, more preferably 0.5 µm or more, and even more preferably 0.8 µm or more.

Also, the average size of each of the convex portions 41 is preferably 0.2 µm or more, more preferably 0.5 µm or more, and even more preferably 0.8 µm or more.

As illustrated in FIG. 3A, the electrolyte layer 40 includes a plurality of crystal grains 42. Each of the convex portions 41 is formed to protrude from the crystal grain 42 on the intermediate layer 50 side surface toward the intermediate layer 50 side. When the crystal grains 42 on the surface of the intermediate layer 50 side are large, the number of crystal grain boundaries decreases, and the resistance (grain boundary resistance) decreases when oxide ions pass through the cross section of the electrolyte layer 40, resulting in good power generation performance. Therefore, it is preferable that the crystal grains 42 on the surface of the intermediate layer 50 side are larger than the convex portions 41. For example, the grain size of the crystal grains 42 on the intermediate layer 50 side surface of the electrolyte layer 40 is the maximum diameter in the direction parallel to the surface, and is preferably 1 µm or more, more preferably 2 µm or more, and 3 µm or more.

The average grain size of the crystal grains 42 on the intermediate layer 50 side surface of the electrolyte layer 40 is preferably 1 µm or more, more preferably 2 µm or more, and even more preferably 3 µm or more. The average value of the grain size of the crystal grains 42 is determined by chemical aging, CP processing, laser processing, or FIB processing after polishing the cross section of the cell so that the grain boundary between the electrolyte layer 40 and the convex portion 41 can be seen. SEM, STEM (Scanning Transmission Electron Microscope), TEM (Transmission Electron Microscope) and other observation methods are used to take cross-sectional images. Among the grains in the electrolyte layer 40 that are in contact with the intermediate layer 50, the grains diameters of grains whose grain boundaries can all be observed may be measured and averaged.

On the other hand, in the electrolyte layer 40, if the crystal grains 42 on the intermediate layer 50 side surface are too large, cracks are likely to occur in the electrolyte layer 40 when the thickness of the electrolyte layer 40 is reduced to 10 µm or less, for example. There is a possibility that a problem such as leakage of the anode gas and the cathode gas may occur. Therefore, it is preferable to set an upper limit for the size of the crystal grains 42 on the intermediate layer 50 side surface. For example, the grain size of the crystal grains 42 on the intermediate layer 50 side surface is preferably 5 µm or less, more preferably 4.5 µm or less, and even more preferably 4 µm or less.

The average grain size of the crystal grains 42 on the intermediate layer 50 side surface of the electrolyte layer 40 is preferably 5 µm or less, more preferably 4.5 µm or less, and further preferably 4 µm or less.

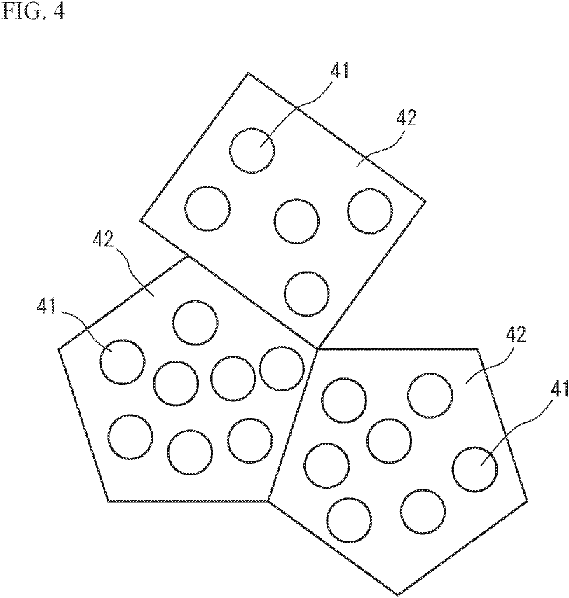

For example, as illustrated in FIG. 4, in a plan view of the electrolyte layer 40, the crystal grain 42 on the intermediate layer 50 side has about 3 to 15 of the convex portions 41. The average number of the convex portions 41 in each of the crystal grains 42 on the intermediate layer 50 side surface of the electrolyte layer 40 is about 3 to 15. By observing the surface of the electrolyte layer 40 with an SEM and increasing the acceleration voltage to 25 kV so as to obtain depth information, the convex portions 41 and the crystal grains 42 can be observed at the same time. The number of the convex portions 41 is measured by counting the number of the convex portions 41 having a size of 0.2 µm or more and 1.5 µm or less on one of the crystal grains 42, as illustrated in FIG. 4. For example, the number of the convex portions 41 on each of 20 or more of the crystal grains 42 can be counted and the average value can be used as the average value. For example, it can be confirmed by cutting off the surface of the portion where the cathode 60 is not printed on the periphery of the cell and observing the surface with an SEM. Further, when the intermediate layer 50 is formed on the surface, the depth information can be confirmed by further increasing the acceleration voltage to, for example, 40 kV.

In addition, in the electrolyte layer 40, it is preferable that the crystal grains 42 and the convex portions 41 on the intermediate layer 50 side surface are integrated without any crystal grain boundaries. Since there is no crystal grain boundary between the convex portions 41 and the crystal grain 42, the grain boundary resistance when oxide ions pass through the electrolyte layer 40 is reduced, and higher power generation performance can be obtained. For example, it is preferable that 50% or more of the convex portions 41 on the intermediate layer 50 side surface do not have crystal grain boundaries between the convex portions 41 and the crystal grain 42 on the intermediate layer 50 side surface of the electrolyte layer 40. It is more preferable that 70% or more of the convex portions 41 on the intermediate layer 50 side surface do not have crystal grain boundaries between the convex portions 41 and the crystal grain 42 on the intermediate layer 50 side surface of the electrolyte layer 40. It is still more preferable that 70% or more of the convex portions 41 on the intermediate layer 50 side surface do not have crystal grain boundaries between the convex portions 41 and the crystal grain 42 on the intermediate layer 50 side surface of the electrolyte layer 40.

The convex-concave interval “b” of the convex portions 41 is about 0.05 to 0.8 times as the grain size of the crystal grains 42 on which the convex portions 41 are provided. As illustrated in FIG. 5B, the convex-concave interval “b” is the average value of the distance from the bottom point of the unevenness formed by the convex portions 41 to the adjacent bottom point in the direction in which the electrolyte layer 40 extends. The vertical distance “a” of the convex portion 41 is about half of the convex-concave interval “b”, and is in the range of 0.025 to 0.4 times as the grain size of the crystal grains on which the convex portions 41 are provided. As illustrated in FIG. 5A, when a straight line is drawn between the bottom point of the unevenness formed by the convex portions 41 and the adjacent bottom point, the vertical distance “a” is the vertical distance from the convex portion 41 between the two bottoms to the straight line. Such measurements are taken at 20 or more locations, and the average value is taken as the average value of the vertical distance “a”.

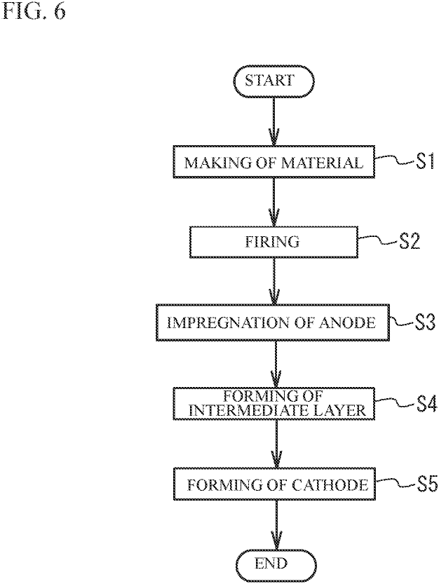

In the following, a description will be given of a manufacturing method of the fuel cell 100. FIG. 6 illustrates a flow of the manufacturing method of the fuel cell 100.

(Making Process of Material for Support) (S1) Metallic powder having a particle size of, for example, 10 µm to 100 µm, a plasticizer, a solvent, a vanishing material, and a binder are mixed to make slurry as a material for support. The amount of the plasticizer is adjusted to, for example, 1 wt% to 6 wt% to adjust the adhesiveness of the sheet. The solvent is toluene, 2-propanol (IPA), 1-butanol, terpineol, butyl acetate, ethanol, or the like. The amount of the solvent is 20 wt% to 30 wt% depending on the viscosity or the like. The vanishing material is an organic substance. The binder is PVB, acrylic resin, ethyl cellulose, or the like. The material for support is used as a material for forming the support 10. The ratio of the volume of the organic components (the vanishing material, the solid component of the binder, and the plasticizer) to the volume of the metallic powder is within a range of, for example, 1:1 to 20:1. The amount of the organic components is adjusted depending on the porosity.

(Making Process of Material for Mixed Layer) (S1) Ceramic material powder, which is the raw material of the ceramic material 22, metallic material powder having a small particle size, which is the raw material of the metallic material 21, a solvent, a plasticizer, a vanishing material, and a binder are mixed to make slurry as a material for mixed layer. The ceramic material powder has a particle size of, for example, 100 nm to 10 µm. The metallic material powder has a particle size of, for example, 1 µm to 10 µm. The solvent is toluene, 2-propanol (IPA), 1-butanol, terpineol, butyl acetate, ethanol, or the like. The amount of the solvent is 20 wt% to 30 wt% depending on the viscosity. The amount of the plasticizer is adjusted to 1 wt% to 6 wt% to adjust the adhesiveness of the sheet. The vanishing material is an organic substance. The binder is PVB, acrylic resin, ethyl cellulose, or the like. The ratio of the volume of the organic components (the vanishing material, the solid component of the binder, and the plasticizer) to the volume of the ceramic material powder and the metallic material powder is within a range of, for example, 1:1 to 5:1. The amount of the organic components is adjusted depending on the porosity. The diameter of the pore is controlled by adjusting the particle size of the vanishing material. The ceramic material powder may contain powder of an electron conductive material and powder of an oxide-ion conductive material. In this case, the ratio of the volume of the powder of the electron conductive material to the volume of the powder of the oxide-ion conductive material is preferably within a range of, for example, 1:9 to 9:1. Use of an electrolyte material such as ScYSZ, GDC, or the like instead of the electron conductive material also prevents the peeling of the boundary face and enables the manufacture of the cell. However, to reduce the ohmic resistance, it is preferable to mix an electron conductive material and metallic powder.

(Making Process of Material for Anode) (S1) Ceramic material powder structuring the electrode bone structure, a solvent, a plasticizer, a vanishing material, and a binder are mixed to make slurry as a material for anode. The solvent is toluene, 2-propanol (IPA), 1-butanol, terpineol, butyl acetate, ethanol, or the like. The amount of the solvent is 20 wt% to 30 wt% depending on the viscosity. The amount of the plasticizer is adjusted to, for example, 1 wt% to 6 wt% to adjust the adhesiveness of the sheet. The vanishing material is an organic substance. The binder is PVB, acrylic resin, ethyl cellulose, or the like. Powder of the electron conductive material that is the raw material of the electron conductive ceramic 31 and has a particle size of, for example, 100 nm to 10 µm and powder of the oxide ion conductive material that is the raw material of the oxide ion conductive ceramic 32 and has a particle size of, for example, 100 nm to 10 µm may be used as the ceramic material powder structuring the electrode bone structure. The ratio of the volume of the organic components (the vanishing material, the solid component of the binder, and the plasticizer) to the volume of the powder of the electron conductive material is within a range of, for example, 1:1 to 5:1, and the amount of the organic components is adjusted depending on the porosity. Additionally, the diameter of the pore is controlled by adjusting the particle size of the vanishing material. The ratio of the volume of the powder of the electron conductive material to the volume of the powder of the oxygen ion conductive material is within a range of, for example, 3:7 to 7:3.

(Making Process of Material for Electrolyte Layer) (S1) Powder of an oxide ion conductive material, a solvent, a plasticizer, and a binder are mixed to make slurry as a material for electrolyte layer. The powder of the oxygen-ion conductive material is, for example, ScYSZ, YSZ, GDC, or the like, and has a D50% diameter of 10 nm to 1000 nm. The solvent is toluene, 2-propanol (IPA), 1-butanol, terpineol, butyl acetate, ethanol, or the like. The amount of the solvent is 20 wt% to 30 wt% depending on the viscosity. The amount of the plasticizer is adjusted to 1 wt% to 6 wt% to adjust the adhesiveness of the sheet. The binder is PVB, acrylic resin, ethyl cellulose, or the like. The ratio of the volume of the organic components (the solid component of the binder and the plasticizer) to the volume of the powder of the oxygen ion conductive material is within a range of, for example, 6:4 to 3:4.

(Making Process of Material for Uneven Layer) (S1) The same material as the electrolyte layer material is used, and the viscosity, additives, solid content concentration or the like are appropriately adjusted so that the dispersibility of the material is poor when preparing the slurry. In addition, resin particles are added to create agglomerates of materials such as ScYSZ, YSZ, GDC. Examples of resin particles include acrylic resin, polystyrene particles, nylon fine particles, and phenol resin. The size of the resin particles is preferably larger than the particle size of the oxide ion conductive material powder. For example, the particle size of the resin particles is 1.5 times or more as that of the oxide ion conductive material powder. Moreover, in order to increase the aggregation effect, the particle size of the resin particles is more preferably three times or more as that of the oxide ion conductive material powder. More preferably, the particle size of the resin particles is at least 5 times as that of the oxide ion conductive material powder. The particle size of the oxide ion conductive material powder in the uneven layer material is preferably smaller than the particle size of the oxide ion conductive material powder in the electrolyte layer material. This is because unevenness is easily formed on the surface of the electrolyte layer 40. For example, the D50% particle size of the oxide ion conductive material powder in the uneven layer material is ⅓ or less of the D50% particle size of the oxide ion conductive material powder in the electrolyte layer material. It is more preferable that the D50% particle size of the oxide ion conductive material powder in the uneven layer material is ⅕ or less of the D50% particle size of the oxide ion conductive material powder in the electrolyte layer material. It is still more preferable that the D50% particle size of the oxide ion conductive material powder in the uneven layer material is ⅒ or less of the D50% particle size of the oxide ion conductive material powder in the electrolyte layer material.

(Firing Process) (S2) A support green sheet is made by applying the material for support on a polyethylene terephthalate (PET) film. A mixed layer green sheet is made by applying the material for mixed layer on another PET film. An anode green sheet is made by applying the material for anode on yet another PET film. An electrolyte layer green sheet is made by applying the material for electrolyte layer on yet another PET film. An uneven layer green sheet is made by applying the material for uneven layer on yet another PET film. For example, the uneven layer green sheet is a thin sheet having a thickness of 1 µm or less, in order to use the uneven layer green sheet as a green sheet to be attached to the surface of the electrolyte layer green sheet. For example, several support green sheets, one mixed layer green sheet, one anode green sheet, one electrolyte layer green sheet, and one uneven layer green sheet are stacked in this order, cut into a predetermined size, and fired within a temperature range of approximately 1100° C. to 1300° C. in a reductive atmosphere with an oxygen partial pressure of 10⁻²⁰ atm or less. Through the above process, a half cell having the support 10, the mixed layer 20, the electrode bone structure of the anode 30, the electrolyte layer 40, and the uneven layer are stacked in this order is obtained.

(Impregnating Process) (S3) Next, the electrode bone structure of the anode 30 is impregnated with the raw materials of the oxide ion conductive ceramic 33 and the catalyst metal 34. For example, the following process is repeated as many times as needed such that Gd-doped ceria or Sc, Y-doped zirconia and Ni are generated when the cell is fired in a reductive atmosphere at a predetermined temperature. Nitrate or chloride of Zr, Y, Sc, Ce, Gd, or Ni is dissolved in water or alcohol (ethanol, 2-propanol, methanol or the like). A half cell is impregnated with the resulting solution, and dried. The resulting half cell is subjected to heat treatment.

(Forming Process of Intermediate Layer) (S4) The intermediate layer 50 is formed by forming a layer of the oxide ion conductive ceramic included in the intermediate layer 50 on the electrolyte layer 40 by PVD or the like. As the intermediate layer 50, Ce_{0.8}Gd_{0.2}O₂₋ₓ is formed so as to have a thickness of 1 µm by, for example, PVD.

(Forming Process of Cathode) (S5) Next, slurry of the material for cathode is applied on the intermediate layer 50 by screen printing and is then dried. After that, the cathode 60 is formed by sintering the material for cathode at a temperature of 1000° C. or less in an air atmosphere. From a view point of suppressing oxidizing of the metal, it is preferable that the thermal process is performed at a temperature of 900° C. or less. It is more preferable that the thermal process is performed at a temperature of 800° C. or less.

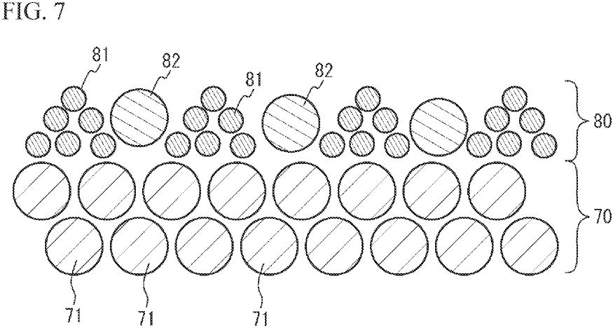

According to the manufacturing method according to the present embodiment, as illustrated in FIG. 7, an uneven layer green sheet 80 is stacked on an electrolyte layer green sheet 70. The particle size of the oxide ion conductive material powder 81 contained in the uneven layer green sheet 80 is smaller than the particle size of the oxide ion conductive material powder 71 contained in the electrolyte layer green sheet 70. In addition, resin particles 82 are included in the uneven layer green sheet 80. The resin particles 82 function as spacers, and the oxide ion conductive material powder 81 aggregates. The resin particles 82 are removed in the firing process. The agglomerated oxide ion conductive material powders 81 become the convex portions 41 after the firing. As a result, the unevenness arranged in two dimensional directions are formed in the intermediate layer 50 side surface of the electrolyte layer 40 after the firing. As a result, the intermediate layer 50 also follows the shape of the surface of the electrolyte layer 40 on the intermediate layer 50 side. Therefore, on the surface of the intermediate layer 50 on the cathode 60 side, the convex portions 51 are formed so as to substantially match the positions of the convex portions 41. In the printing method, it is difficult to form unevenness only in one-dimensional direction within the plane. However, in the manufacturing method according to this embodiment, the unevenness can be formed in the two-dimensional direction within the plane. The surface of the intermediate layer 50 on the side of the electrolyte layer 40 is also uneven along the surface of the electrolyte layer 40 on the side of the cathode 60. Further, the surface of the cathode 60 on the intermediate layer 50 side is also uneven so as to follow the shape of the surface of the intermediate layer 50 on the cathode 60 side.

### EXAMPLES

The fuel cell 100 was manufactured according to the manufacturing method according to the above embodiment.

(Example 1) SUS (stainless steel) powder was used as the material for support. ScYSZ was used as the ceramic material for the electrolyte layer. Acrylic resin, polystyrene particles, nylon fine particles, phenolic resin or the like were added as resin particles to the material for uneven layer. A LaCrO₃-based material was used for the electron conductive ceramic of the material for anode, and ScYSZ was used for the oxide ion conductive ceramic. GDC was used as the ceramic material for intermediate layer. LSC was used as the ceramic material for cathode. A LaCrO₃-based material was used as the ceramic material for mixed layer. SUS was used as the metal material for mixed layer. A mixed layer green sheet, an anode green sheet, an electrolyte layer green sheet, and an uneven layer green sheet were stacked on a support green sheet, cut into a predetermined size, and fired in a reducing atmosphere with an oxygen partial pressure of 10⁻¹⁶ atm or less. After impregnating the electrode bone of the anode with GDC and Ni, the multilayer structure was fired at a temperature of 850° C. or less in an air atmosphere. After that, an intermediate layer of Ce_{0.8}Gd_{0.2}O₂₋ₓ was formed by PVD, and the material for cathode was applied onto the intermediate layer by screen printing or the like and dried. Thereafter, the material for cathodel was sintered by heat treatment in an air atmosphere at a temperature of 1000° C. or less to form a cathode. In Example 1, the vertical distance “a” was 100 nm, and the concave-convex interval “b” was 500 nm. Further, it was confirmed that 90% or more of the convex portions 51 on the intermediate layer 50 side surface did not have crystal grain boundaries between the convex portions 51 and the crystal grains on the intermediate layer 50 side surface of the electrolyte layer 40. The surface of the fired half-cell was observed with an SEM, and the number of the convex portions 41 existing on the crystal grains 42 at 20 locations was counted, and the average value was 11. After that, a PVD process was performed to print a cathode and make a full cell. After conducting the power generation evaluation, the cross section of the cell was observed. When the grain size of the crystal grains 42 in the cross section was measured, the average value was 3 µm. Further, the cross-sectional observation confirmed the presence of grain boundaries between the convex portions 51 on the intermediate layer 50 side surface and the crystal grains on the intermediate layer 50 side surface of the electrolyte layer 40. Furthermore, the average value of the vertical distance “a” and the average value of the concave-convex interval “b” could be measured from the photograph of the same cross section. The average values of the vertical distance “a” and the concave-convex interval “b” were 100 nm and 500 nm, respectively.

(Example 2) In Example 2, NiO/YSZ was used as the material for support. Other manufacturing conditions were the same as in Example 1. In Example 2, the vertical distance “a” was 100 nm and the concave-convex interval “b” was 500 nm. Further, it was confirmed that 90% or more of the convex portions 51 on the intermediate layer 50 side surface did not have crystal grain boundaries between the convex portions 51 and the crystal grains on the intermediate layer 50 side surface of the electrolyte layer 40. When the number of the convex portions 41 present on the crystal grains 42 was counted in the same manner as in Example 1, the average number was 11. After the power generation was evaluated in the same manner as in Example 1, the cross section was observed, and the average grain size of the crystal grains 42 was 3 µm. Furthermore, the average value of the vertical distance “a” and the average value of the concave-convex interval “b” were 100 nm and 500 nm, respectively.

(Example 3) In Example 3, the manufacturing conditions of the uneven sheet were changed, the ratio of the resin material was increased, and the number of the convex portions 41 present on the surface of the crystal grains 42 was reduced. Other manufacturing conditions were the same as in Example 1. In Example 3, the vertical distance “a” was 100 nm and the concave-convex interval “b” was 800 nm. Further, it was confirmed that 90% or more of the convex portions 51 on the intermediate layer 50 side surface did not have crystal grain boundaries between the convex portions 51 and the crystal grains on the intermediate layer 50 side surface of the electrolyte layer 40. When the number of the convex portions 41 present on the crystal grains 42 was counted in the same manner as in Example 1, the average number was seven. Further, when the section was observed after power generation was evaluated in the same manner as in Example 1, the average grain size of the crystal grains 42 was 3 µm. Furthermore, the average value of the vertical distance “a” and the average value of the concave-convex interval “b” were 100 nm and 800 nm, respectively.

(Comparative Example) In Comparative Example, the green sheet for the uneven layer was not provided. Other conditions were the same as in Example 1. In Comparative Example, since the green sheet for the uneven layer was not provided, unevenness did not appear on the surface of the electrolyte layer on the cathode side, and unevenness did not appear on the intermediate layer and the cathode.

(Power Generation Evaluation) By performing impedance measurement on the fuel cells of Examples 1 to 3 and Comparative Example, each resistance value was separated, and the ohmic resistance of the entire fuel cell and the reaction resistance of the cathode were measured. Table 1 shows the results. As shown in Table 1, Comparative Example had an ohmic resistance of 0.25 Ω·cm². It is considered that the reason why the ohmic resistance was low in Comparative Example was that no convex portions were formed on the intermediate layer side surface of the electrolyte layer. For Examples 1 and 3, the ohmic resistance was 0.25 Ω·cm². In Example 2, the ohmic resistance was 0.30 Ω·cm². Thus, in Example 1 and Example 2, the ohmic resistance was also lowered. This is probably because the convex portions on the intermediate layer side surface of the electrolyte layer did not form grain boundaries with crystal grains on the intermediate layer side surface of the electrolyte layer. The reason why the ohmic resistances of Examples 1 and 3 were lower than that of Example 2 is considered to be that a metal support with high electronic conductivity was used.

TABLE 1

| | INTERMEDIATE LAYER UNEVENNESS | SUPPORT | a AVERAGE | b AVERAGE | average grain diameter D of crystal grain | a/D | b/D | AVERAGE OF CONVEX PORTIONS OF CRYSTAL GRAIN | RATIO OF GRAIN WITHOUT GRAIN BOUNDARY | OHMIC RESISTANCE (Ω · cm²) | CATHODE REACTION RESISTANCE (Ω · cm²) |
|---|---|---|---|---|---|---|---|---|---|---|---|
| EXAMPLE 1 | EXIST | METAL | 100 nm | 500 nm | 3 µm | 0.033 | 0.17 | 11 | 90% | 0.25 | 0.27 |
| EXAMPLE 2 | EXIST | NIO/YSZ | 100 nm | 500 nm | 3 µm | 0.033 | 0.17 | 11 | 90% | 0.30 | 0.27 |
| EXAMPLE 3 | EXIST | METAL | 100 nm | 800 nm | 3 µm | 0.033 | 0.27 | 7 | 90% | 0.25 | 0.31 |
| COMPARATIVE EXAMPLE | NONE | METAL | -- | -- | -- | -- | -- | -- | -- | 0.25 | 0.56 |

In Example 1, the reaction resistance at the cathode was 0.27 Ω·cm². In Example 2, the reaction resistance at the cathode was 0.27 Ω·cm². In Example 3, the reaction resistance at the cathode was 0.31 Ω·cm². Thus, in Examples 1 to 3, the reaction resistance at the cathode was low. This is because the surface of the electrolyte layer on the intermediate layer side was two-dimensionally uneven, so that the surface of the intermediate layer on the cathode side was also uneven, and the contact area between the intermediate layer and the cathode increased. It is considered that, in Comparative Example, the reaction resistance at the cathode was 0.56 Ω·cm², which was significantly higher. It is considered that this was because the intermediate layer was not formed with unevenness, so that the contact area between the intermediate layer and the cathode was not sufficiently large.

Although the embodiments of the present invention have been described in detail, it is to be understood that the various change, substitutions, and alterations could be made hereto without departing from the spirit and scope of the invention.

1. A solid oxide fuel cell comprising:
an electrolyte layer including a solid oxide having oxide ion conductivity;
an intermediate layer that is provided on the electrolyte layer and has oxide ion conductivity; and
a cathode provided on the intermediate layer,
wherein the electrolyte layer has a plurality of convex portions arranged in dimensional directions in a plan view, on a face thereof on the side of the intermediate layer, and
wherein a face of the intermediate layer on the side of the cathode follows a shape of the face of the electrolyte layer on the side of the intermediate layer.

2. The solid oxide fuel cell as claimed in claim 1,
wherein the plurality of convex portions have a grain shape.

3. The solid oxide fuel cell as claimed in claim 1, wherein:
the electrolyte layer includes a plurality of crystal grains;
the convex portions protrude toward the intermediate layer from the crystal grain on a surface of the electrolyte layer on the side of the intermediate layer;
the crystal grains on the surface of the electrolyte layer on the side of the intermediate layer are larger than the convex portions.

4. The solid oxide fuel cell as claimed in claim 3,
wherein a size of the crystal grains on the surface of the electrolyte layer on the side of the intermediate layer is 1 µm or more and 5 µn or less.

5. The solid oxide fuel cell as claimed in claim 3,
wherein a number of the convex portions on each of the crystal grains on the surface of the electrolyte layer on the side of the intermediate layer is 3 to 15, in a plan view with respect to the electrolyte layer.

6. The solid oxide fuel cell as claimed in claim 3, wherein there is no crystal grain boundary between at least one of the convex portions and the crystal grains on the surface of the electrolyte layer on the side of the intermediate layer.

7. The solid oxide fuel cell as claimed in claim 3, wherein a size of the convex portions is in a range of 0.05 to 0.8 times as a size of the crystal grains on the surface of the electrolyte layer on the side of the intermediate layer.

8. The solid oxide fuel cell as claimed in claim 3, wherein a height of the convex portions is in a range of 0.025 to 0.4 times as a size of the crystal grains on the surface of the electrolyte layer on the side of the intermediate layer.

9. The solid oxide fuel cell as claimed in claim 1, wherein a size of the convex portions is 0.2 µm or more and 1.5 µm or less.

10. A manufacturing method of a solid oxide fuel cell comprising:
forming an electrolyte layer green sheet by applying slurry including oxide ion conductive material powder;
applying slurry including oxide ion conductive material powder and resin particles on the electrolyte layer green sheet and, after that, firing the electrolyte layer green sheet, the oxide ion conductive material powder having a D50% particle diameter smaller than a D50% particle diameter of the oxide ion conductive material powder of the electrolyte layer green sheet;
forming an intermediate layer on an electrolyte layer obtained by the firing, the intermediate layer having oxide ion conductivity and not having cathode activity; and
forming a cathode on the intermediate layer.
